(19) United States
(12) Patent Application Publication
(10) Pub. No.: US 2007/0268866 A1
(43) Pub. Date: Nov. 22, 2007

(54) IEEE 802.15.4 NETWORK SYSTEM PROVIDING MOBILITY AND OPERATING METHOD THEREOF

(75) Inventor: Soon Jin CHOI, GYUNGGI-DO (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/750,171

(22) Filed: May 17, 2007

(30) Foreign Application Priority Data
May 22, 2006 (KR) 10-2006-0045790

(51) Int. Cl. H04Q 7/00

(52) U.S. Cl. 370/331

(57) ABSTRACT

An IEEE 802.15.4 network system capable of directly controlling a stationary device without through a coordinator. The IEEE 802.15.4 network system includes: at least one stationary device allocated with an address and an ID indicating a preset device type to be associated with the IEEE 802.15.4 network; and a coordinator for allocating the address and the ID to the stationary device to be associated with the network. The coordinator has allocation address information and allocation ID information related, respectively, to the address and the ID allocated to the stationary device. A mobile device is associated with the network through the coordinator to receive the allocation address information and the allocation ID information of the stationary device from the coordinator to directly control the stationary device without through the coordinator.

### CLAIM OF PRIORITY

This application claims the benefit of Korean Patent Application No. 2006-45790 filed on 22, May, 2006, in the Korean Intellectual Property Office, the disclosure of which is incorporated herein by reference.

### BACKGROUND OF THE INVENTION

1. Field of the Invention

The present invention relates to an IEEE 802.15.4 network system providing mobility and an operation method thereof, more particularly, capable of directly controlling a stationary device.

2. Description of the Related Art

In general, the IEEE 802.15.4 network refers to a Low Rate Wireless Personal Area Network (LR-WPANs) according to the Zigbee alliance specification. (The term “IEEE” is the short form of Institute of Electrical and Electronics Engineers.) The IEEE 802.15.4 network carries out communicating using a frequency band divided into three (3) bands, in which different spreading types and data rates are set to respective frequency bands.

Such an IEEE 802.15.4 network has been aimed to produce small-sized, low voltage and low price products, and is currently being regarded as a technique for short range communication of 10 to 20 m in wireless networking at home or office and for ubiquitous computing which is currently in the rise.

FIG. 1 is a configuration diagram illustrating a network according to a general IEEE 802.15.4 standard.

Referring to FIG. 1, a typical IEEE 802.15.4 network 10 includes a coordinator (COR) 11 and first to fourth stationary devices 12a to 12d.

The coordinator 11 is networked with the first to fourth stationary devices 12a to 12d to manage the network 10 as well as to control the first to fourth stationary devices 12a to 12d.

The first to fourth stationary devices 12a to 12d execute their own operations in response to the control of the coordinator 11.

The network 10 may further include a mobile device (MD) 13.

The mobile device 13 is movable in an area where it can communicate with the coordinator 11 of the network 10, and executes its own operation through the communication with the coordinator 11.

FIG. 2 is a flow diagram illustrating a typical IEEE 802.15.4 network operating method.

Referring to FIG. 2 together with FIG. 1 described above, the first stationary device 12a is associated with the coordinator 11. In S201, the mobile device 13 transmits a Zigbee association request command to the coordinator 11.

The coordinator 11 then transmits an acknowledgment to the mobile device 13, acknowledging the receipt of the Zigbee association request command in S202.

Then, in S203, the mobile device 13 transmits a data request command to the coordinator 11, informing that the mobile device 13 is in receivable position.

The coordinator 11 then transmits an acknowledgment to the mobile device 13, acknowledging the receipt of the data request command in S204.

Then, in S205, the coordinator 11 allocates address to the mobile device 13 and transmits an association response command to the mobile device 13 to inform that the mobile device 13 is associated with the network 10. As a result, based on the allocated address, the mobile device 13 can communicate with the coordinator 11.

FIG. 3 is a configuration diagram illustrating a packet transmitted from the coordinator in the IEEE 802.15.4 network.

Referring to FIGS. 1 to 3, the association response command packet transmitted from the coordinator 11 to the device 13 is composed of a header field HDR, a command identification field CMD ID and so on. The association response command packet includes an address field ADDR having address information allocated to the mobile device 13.

The mobile device 13 is allocated with the address information by the coordinator 11 and then associated with the network 10.

However, the problem is that the mobile device 13 cannot be associated with the network 10 when it is moved out of a preset range where the communication power of the coordinator is reachable. Furthermore, the mobile device 13 cannot recognize the existence of the respective stationary devices except for the coordinator 11 or control the respective stationary devices.

### SUMMARY OF THE INVENTION

The present invention has been made to solve the foregoing problems of the prior art and it is therefore an aspect of the present invention to provide an IEEE 802.15.4 network capable of directly controlling a stationary device.

Another aspect of the invention is to provide an operation method of an IEEE 802.15.4 network capable of directly controlling a stationary device in the IEEE 802.15.4 network.

According to an aspect of the invention, the IEEE 802.15.4 network system of the invention includes: at least one stationary device allocated with an address for association with an IEEE 802.15.4 network and an ID indicating a preset device type to be associated with the IEEE 802.15.4 network; a coordinator for allocating the address and the ID to the stationary device to be associated with the network, the coordinator having allocation address information and allocation ID information related, respectively, to the address and the ID allocated to the stationary device; and a mobile device associated with the network through the coordinator, the mobile device receiving the allocation address information and the allocation ID information of the stationary device from the coordinator to control the stationary device.

According to an embodiment of the invention, the mobile device may directly control the stationary device without through the coordinator, in particular, when the mobile device is out of a preset range where the communication power of the coordinator is reachable.

According to an embodiment of the invention, the allocation address information and the allocation ID information of the stationary device transmitted from the coordinator may be formed into a first packet preset between the coordinator and the mobile device. Accordingly, the first packet may include an address field and a Virtual Address Table (VAT) field, wherein the address field has allocation address information related with an address allocated to the mobile device for association with the network, and wherein the VAT field has the allocation address information and the allocation ID information of the stationary device.

According to an embodiment of the invention, the allocation address information and the allocation ID information of the stationary device transmitted from the coordinator may be formed into a second packet according to Zigbee alliance specification. Accordingly, the second packet includes Media Access Controller (MAC) payload field, wherein the MAC payload field has the allocation address information and the allocation ID information of the stationary device.

According to an embodiment of the invention, the ID may indicate a device type according to Zigbee alliance specification.

According to another aspect of the invention, the invention provides a method of operating an IEEE 802.15.4 network by a mobile device, in which the network includes a coordinator, at least one stationary device and a mobile device. The method includes steps of: transmitting an association request command to the coordinator; upon receiving an acknowledgment from the coordinator in response to the association request command, transmitting a data request command to the coordinator; upon receiving an acknowledgment from the coordinator in response to the data request command, associating with the network, and upon receiving allocation address information related with an address allocated to the stationary device for association with the network and an allocation ID information allocated to the stationary device and related with an ID indicating a preset device type, transmitting an acknowledgment to the coordinator in response to the allocation address information and the allocation ID information of the stationary device; and controlling the stationary device based on the allocation address information and the allocation ID information of the stationary device and receiving an acknowledgment from the stationary device in response to the mobile device controlling the stationary device.

According to another embodiment of the invention, the method includes steps of: transmitting an association request command to the coordinator; upon receiving an acknowledgment from the coordinator in response to the association request command, transmitting a first data request command to the coordinator, which requests allocation of an address for association with an IEEE 802.15.4 network; upon receiving an acknowledgment from the coordinator in response to the data request command, associating with the network; transmitting a second data request command to the coordinator to request allocation address information and allocation ID information from the coordinator, the allocation address information related with an address allocated to the stationary device for association with the network and the allocation ID information related with an ID indicating a preset device type allocated to the stationary device; receiving an acknowledgment from the coordinator in response to the second data request command, receiving the allocation address information and the allocation ID information of the stationary device from the coordinator, and transmitting an acknowledgment to the coordinator in response to the allocation address information and the allocation ID information of the stationary device; and controlling the stationary device based on the allocation address information and the allocation ID information of the stationary device and receiving an acknowledgment from the stationary device in response to the mobile device controlling the stationary device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram illustrating a general IEEE 802.15.4 network;

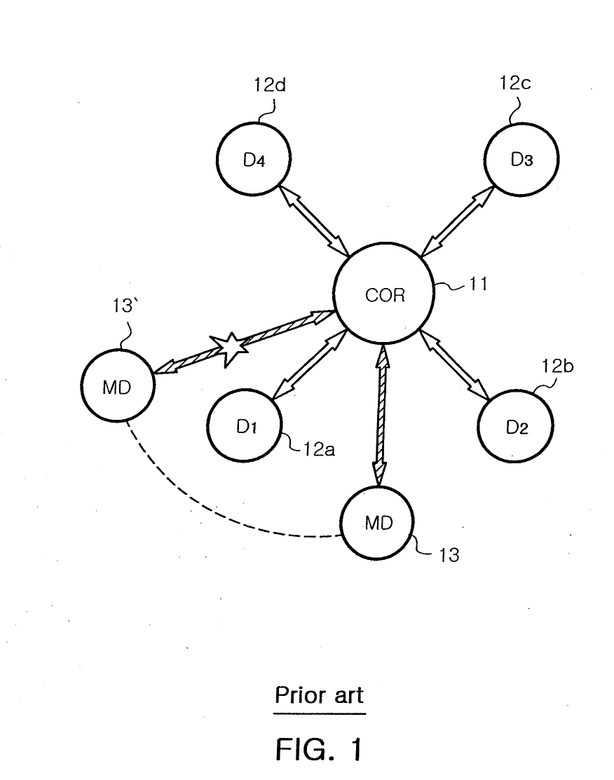

FIG. 2 is a flow diagram illustrating a typical IEEE 802.15.4 network operating method;

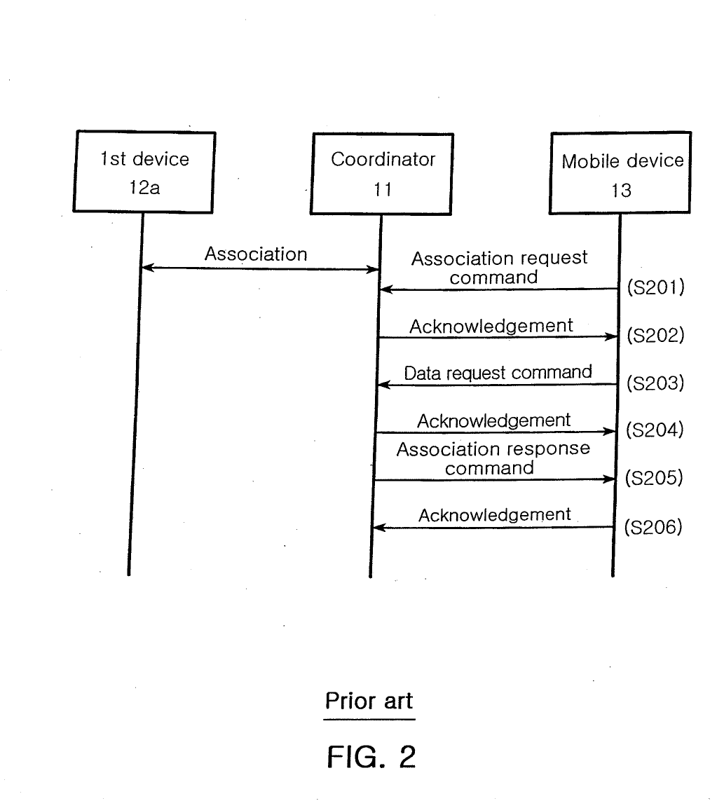

FIG. 3 is a configuration diagram illustrating a packet transmitted from the coordinator in the IEEE 802.15.4 network;

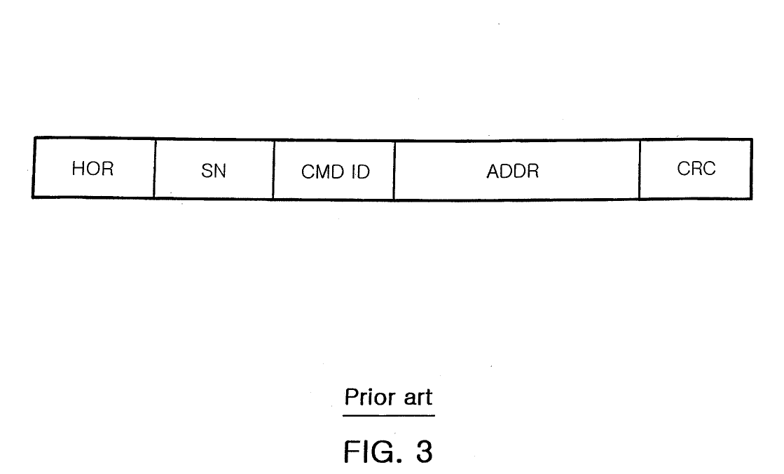

FIG. 4 is a configuration diagram illustrating an IEEE 802.15.4 network providing mobility according to the invention;

FIG. 5 is a flow diagram illustrating an embodiment of an IEEE 802.15.4 network operating method providing mobility according to the invention;

FIG. 6 is a flow diagram illustrating another embodiment of an IEEE 802.15.4 network operating method providing mobility according to the invention;

FIGS. 7 (a) and (b) are configuration diagrams illustrating packets transmitted from the coordinator in the IEEE 802.15.4 network providing mobility according to the invention;

FIG. 8 is a configuration diagram illustrating an exemplary table in the packet shown in FIG. 7; and

FIG. 9 is a flow diagram illustrating an IEEE 802.15.4 network providing mobility and a setting method thereof according to the invention.

### DETAILED DESCRIPTION OF THE PREFERRED EMBODIMENT

The present invention will now be described more fully hereinafter with reference to the accompanying drawings, in which preferred embodiments of the invention are shown.

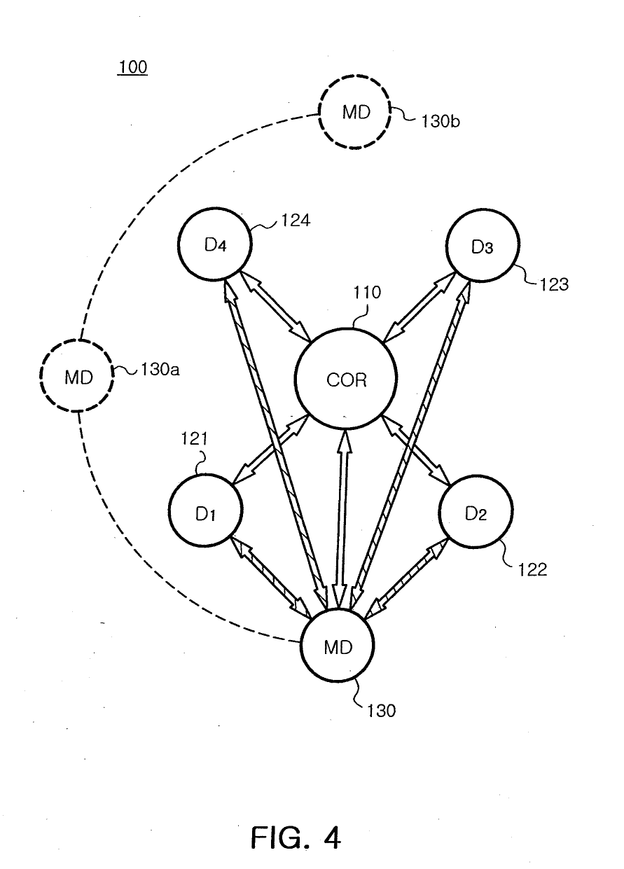

FIG. 4 is a configuration diagram illustrating an IEEE 802.15.4 network 100 providing mobility according to the invention.

Referring to FIG. 4, the IEEE 802.15.4 network 100 includes a coordinator 110, first to fourth stationary devices 121 to 124 and a mobile device 130.

The coordinator 110 allocates preset address and ID to the first to fourth stationary devices 121 to 124 to establish the IEEE 802.15.4 network 100, and serves to manage the network 100. The coordinator 110 has address information related with addresses allocated to the first to fourth devices 121 to 124 and ID information related with IDs allocated to the same. The address information refers to address numbers which are allocated to the first to fourth devices at the time of network association, whereas the ID information refers to IDs allocated to the first to fourth stationary devices to indicate preset device type. The ID can be set according to mutual agreement among users or according to the Zigbee alliance specification.

The first to fourth stationary devices 121 to 124 are connected to the network 100 based on the above-mentioned addresses and IDs allocated by the coordinator 110, and then execute preset operations under the control of the coordinator 110.

The mobile device 130 is associated with the network 100 by the access to the coordinator 110, and with preset information provided from the coordinator 110, directly controls the first to fourth stationary devices 121 to 124 while moving freely in the network 100.

The preset information includes the address and ID information of the first to fourth stationary devices 121 to 124.

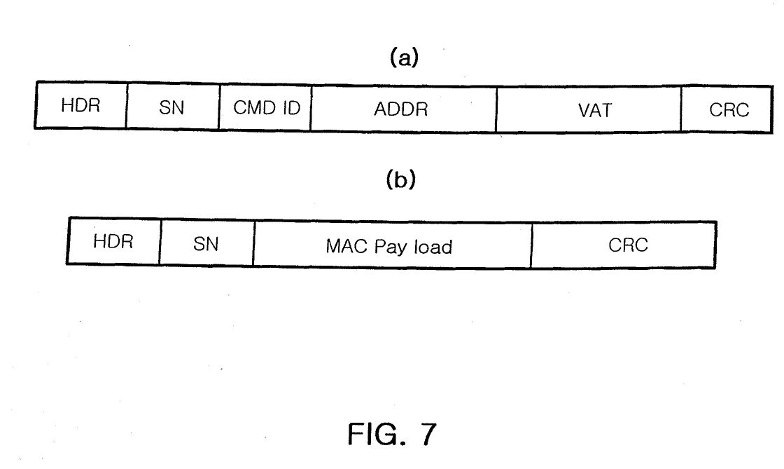

The address and ID information is transmitted in the form of packets, which will be described in detail with reference to FIGS. 7 (a) and (b).

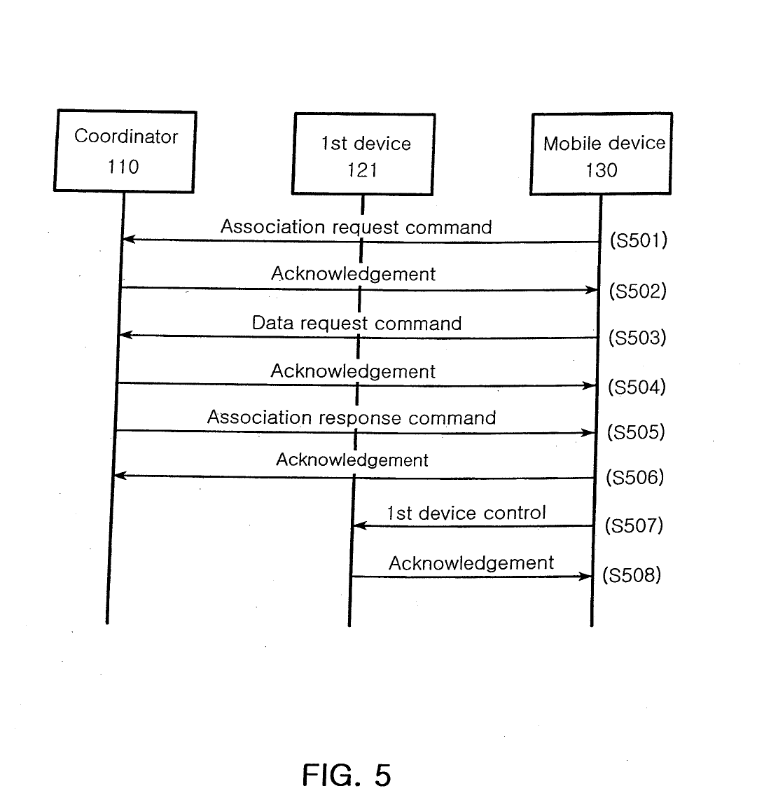

FIG. 5 is a flow diagram illustrating an embodiment of an IEEE 802.15.4 network operating method providing mobility according to the invention.

Referring to FIG. 5, in this embodiment of the IEEE 802.15.4 network operating method providing mobility, the mobile device 130 requests the coordinator 110 for association with the network 100 according to steps S501 to S504.

Then, in steps S505 and S506, the mobile device 130 is associated with the network 100 by the coordinator 110, and provided with the address and ID information of the stationary devices 121 to 124 from the coordinator 110.

Finally, in S507, the mobile device 130 directly controls the stationary devices 121 to 124 by using the address and ID information thereof, and in S508, receives an acknowledgment in response to the direct control.

This embodiment of the IEEE 802.15.4 network operating method providing mobility will be described in more detail later in connection with the operation of the invention.

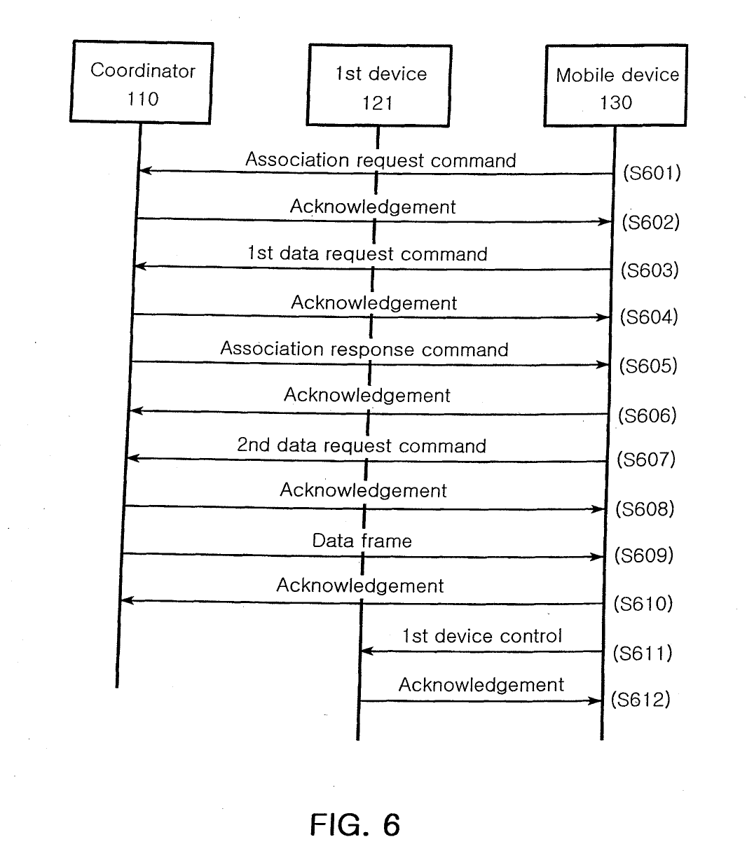

FIG. 6 is a flow diagram illustrating another embodiment of the IEEE 802.15.4 network operating method providing mobility according to the invention.

Referring to FIG. 6, in this embodiment of the IEEE 802.15.4 network operating method providing mobility, the mobile device 130 requests the coordinator 110 for association with the network 100 according to steps S601 to S604.

Based on an acknowledgment from the coordinator 110 in response to the association request, the mobile device 130 is associated with the network 100 in steps S605 and S606.

Then, the mobile device 130 requests the coordinator 110 for the address and ID information of the stationary devices and receives the address and ID information from the coordinator 110 in S607 to S610.

Finally, the mobile device 130 directly controls the stationary devices 121 to 124 in S611 and S612.

This embodiment of the IEEE 802.15.4 network operating method providing mobility will be described in more detail later in connection with the operation of the invention.

FIGS. 7 (a) and (b) are configuration diagrams illustrating packets transmitted from the coordinator in the IEEE 802.15.4 network providing mobility according to the invention.

FIG. 7 (a) shows the structure of a packet transmitted from the coordinator in response to a data request command of the mobile device.

The packet is composed of a header field HDR, a sequence number field SN, a command ID field CMD ID, an address field ADDR, a Virtual Address Table (VAT) field VAT and a Cyclic Redundancy Check (CRC) field CRC.

The header field HDR, the sequence number field SN, the command ID field CMD ID, the address field ADDR and the CRC field CRC are fields composed according to the IEEE 802.15.4 protocol.

The address field ADD includes address information allocated to the mobile device, and the command ID field includes identifier information indicating the type of the command that is currently in use.

The VAT field VAT includes the address information allocated to the respective stationary devices by the coordinator and their ID information.

FIG. 7 (b) shows the structure of a data frame packet transmitted from the coordinator to the mobile device in response to a second data request command therefrom.

The data frame packet is composed of a header field HDR, a sequence number field SN, a Media Access Controller (MAC) payload field MAC Payload and a CRC field CRC.

The header field HDR, the sequence number field SN, the MAC payload field MAC Payload and the CRC field CRC are composed according to the IEEE 802.15.4 protocol, and a VAT field including the address information allocated to the respective stationary devices by the coordinator and their ID information is included in the MAC payload field.

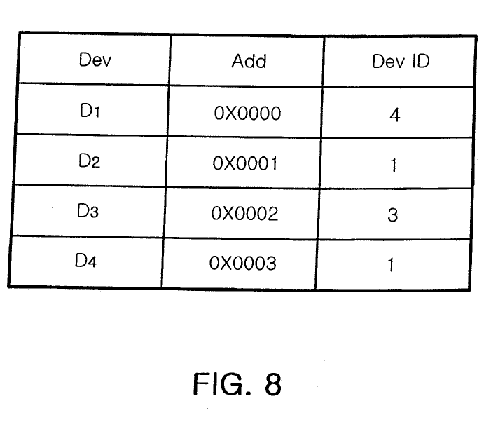

FIG. 8 is a configuration diagram illustrating an exemplary table in the packet shown in FIG. 7.

Referring to FIG. 8, the VAT field shown in FIGS. 7 (a) and (b) may be realized in the form of a virtual address table.

The address and ID information included in the VAT field is classified according to the respective stationary devices into the table.

The address information of the stationary device may have a two (2) or eight (8) byte size, and the ID information of the stationary device may have a one (1) byte size.

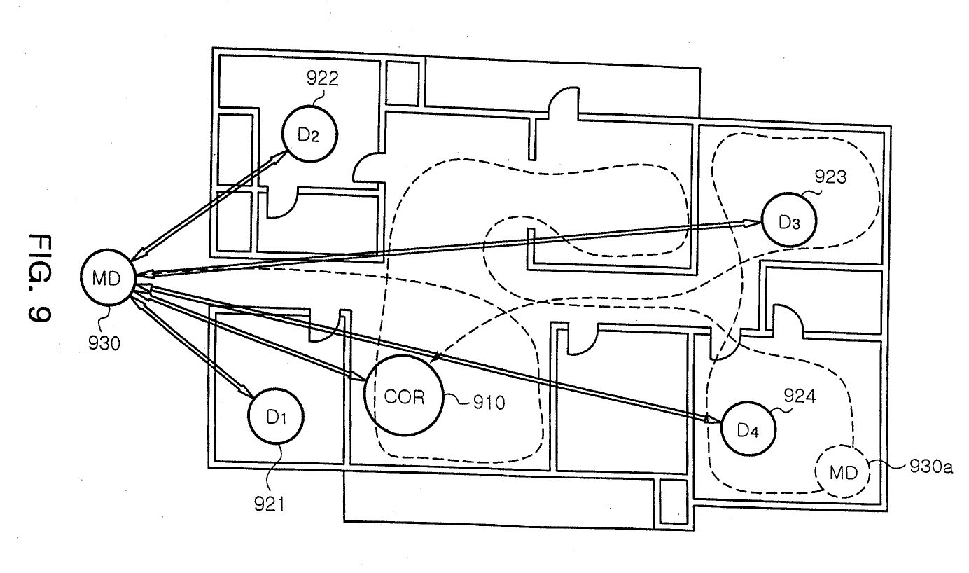

FIG. 9 is a flow diagram illustrating an embodiment of the IEEE 802.15.4 network providing mobility and a setting method thereof according to the invention.

Referring to FIG. 9, the embodiment of the IEEE 802.15.4 network providing mobility and the setting method thereof according to the invention is applied to a home as an example.

Hereinafter the operation of the invention will be described in detail with reference to the accompanying drawings.

Referring to FIGS. 4, 5 and 7 (a), in one embodiment of the IEEE 802.15.4 network setting method providing mobility according to the invention, the coordinator 110 and the first to fourth stationary devices 121 to 124 are mutually associated. The coordinator 110 possesses the address and ID information of the respective stationary devices 121 to 124 in use for controlling the respective stationary devices 121 to 124.

The mobile device 130 transmits an association request command to the coordinator 110 in use for association with the network 100 in S501.

In S502, in response to the association request command, the coordinator 110 transmits an acknowledgement to the mobile device 130.

In S503, the mobile device 130 receives the acknowledgment from the coordinator 110 and transmits a data request command to the coordinator 110.

In response to the data request command from the mobile device 130, the coordinator 110 transmits an acknowledgment to the mobile device 130 in S504.

In S505, the coordinator 110 transmits an association response command to the mobile device 130. The association response command is in the form of a packet shown in FIG. 7 (a).

The address field ADDR in the packet includes the address information allocated to the mobile device 130 in the network, such that the mobile device 130 is associated with the network based on the address information.

The packet also includes the VAT field VAT which contains the address and ID information of the first to fourth stationary devices 121 to 124 which are already associated with the network.

Based on the address and ID information of the first to fourth stationary devices, the mobile device 130 can directly control the first to fourth devices. In a case where the mobile device 130 is located out of a power zone preset by the coordinator, the mobile device 130 can directly control the first to fourth stationary devices without through the coordinator 110.

In S506, the mobile device 130 transmits an acknowledgment in response to the association response command from the coordinator 110.

Then, in S507, the mobile device 130 directly controls the first to fourth stationary devices 121 to 124 based on the address and ID information of the first to fourth stationary devices included in the association response command. Although FIG. 5 shows that the mobile device directly controls the first stationary device 121, it is not intended limiting.

In this embodiment of the IEEE 802.15.4 network operating method providing mobility according to the invention, the packet transmitted from the coordinator 110 to the mobile device 130 is not provided in the Zigbee alliance specification but previously set between the coordinator 110 and the mobile device 130.

Accordingly, the mobile device 130 directly controls the first to fourth stationary devices 121 to 124 without through the coordinator 110 while moving freely in the network 100.

Then, in S508, the mobile device 130 receives an acknowledgment from the first stationary device 121 that is under the direct control of the mobile device 130.

Referring to FIGS. 4, 5 and 7 (b), in another embodiment of the IEEE 802.15.4 network operating method providing mobility according to the invention, the coordinator 110 and the first to fourth stationary devices 121 to 124 are mutually associated. The coordinator 110 possesses the address and ID information of the respective stationary devices 121 to 124 in use for controlling the respective stationary devices 121 to 124.

The mobile device 130 transmits an association request command to the coordinator 110 in use for association with the network 100 in S601.

In S602, in response to the association request command, the coordinator 110 transmits an acknowledgement to the mobile device 130.

In S603, the mobile device 130 receives the acknowledgment from the coordinator 110 and transmits a first data request command to the coordinator 110. The first data request command is made to request an address to be allocated from the coordinator 110 to the mobile device 130, which is in use for association with the network 100.

In response to the first data request command from the mobile device 130, the coordinator 110 transmits an acknowledgment to the mobile device 130 in S604.

In S605, the coordinator 110 transmits an association response command to the mobile device 130. The association response command is in the form of a packet according to the Zigbee alliance specification. The packet includes address information allocated to the mobile device 130, by which the mobile device 130 is associated with the network 100.

In S606, the mobile device 130 transmits an acknowledgment in response to the association response command from the coordinator 110.

Then, in case of attempting to directly control the respective stationary devices, the mobile device 130 transmits a second data request command to the coordinator 110 in S607. The second data request command is a command for requesting address and ID information of the first to fourth stationary devices from the coordinator 110.

In response to the second data request command, the coordinator 110 transmits an acknowledgment to the mobile device 130 in S608.

Then, in S609, the coordinator 110 transmits a data frame in response to the second data request command to the mobile device 130.

The data frame is realized in the form of a packet shown in FIG. 7 (b). The packet, composed according to the Zigbee alliance specification, includes an MAC payload field MAC Payload having the address and ID information of the first to fourth stationary devices 121 to 124.

In S610, in response to the data frame received above, the mobile device 130 transmits an acknowledgment to the coordinator 110.

The mobile device 130 directly controls the first to fourth stationary devices based on the address and ID information of the first to fourth stationary devices in the MAC payload field in S611.

Finally, in S612, the mobile device 130 receives an acknowledgment from the first stationary device 121 that is under the direct control of the mobile device 130.

In this embodiment of the IEEE 802.15.4 network operating method providing mobility according to the invention as described above, the address and ID information of the respective stationary devices is transmitted between the coordinator 110 and the mobile device 130, on the packet composed according to the Zigbee alliance specification. Accordingly, the mobile device 130 directly controls the first to fourth stationary devices 121 to 124 while moving freely in the network 100 as indicated with the reference signs 130a and 130b.

The embodiment of the IEEE 802.15.4 network system providing mobility and the operating method thereof according to the invention can be applied to an office or home as an example.

FIG. 9 shows an embodiment of the IEEE 802.15.4 network providing mobility and the operating method thereof according to the invention.

Referring to FIG. 9, the coordinator 910 may be provided in a refrigerator or TV equipped at home to manage the network.

Examples of the first to fourth stationary devices 921 to 924 may include a light lamp, a front door and so on of a home.

The mobile device 930 directly controlling the respective stationary devices 921 to 924 based on address and ID information obtained from the coordinator 910 at request may be provided as a mobile phone or a small sized remote controller including a Zigbee module, which can be easily carried by the user.

The user carrying the mobile device 930 realized as the mobile phone or remote controller can directly control the stationary devices while moving freely in the interior of the house.

The coordinator 910 can forward a control signal from the mobile device to the respective stationary devices 921 to 924, if the control signal does not correspond to the coordinator 910. Accordingly, upon receiving control signals from both of the mobile device 930 and the coordinator 910, the stationary devices 921 to 924 may disregard the control signal from the coordinator 910.

According to an exemplary embodiment of the invention as set forth above, the mobile device can receive address and ID information of the respective stationary devices from the coordinator and thus directly control the respective stationary devices based on the address and ID information. Furthermore, the mobile device can readily control the respective stationary devices even if located out of a preset range where the communication power of the coordinator is reachable. Moreover, since a separate access point is not used, the network or network operation method can be realized at an inexpensive price.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

What is claimed is:

1. An IEEE 802.15.4 network system comprising:
at least one stationary device allocated with an address for association with an IEEE 802.15 network and an ID indicating a preset device type to be associated with the IEEE 802.15.4 network;
a coordinator for allocating the address and the ID to the stationary device to be associated with the network, the coordinator having allocation address information and allocation ID information related, respectively, to the address and the ID allocated to the stationary device; and
a mobile device associated with the network through the coordinator, the mobile device receiving the allocation address information and the allocation ID information of the stationary device from the coordinator to control the stationary device.

2. The IEEE 802.15.4 network system according to claim 1, wherein the mobile device is adapted to directly control the stationary device without through the coordinator.

3. The IEEE 802.15.4 network system according to claim 1, wherein the mobile device is adapted to directly control the stationary device without through the coordinator when the mobile device is out of a preset range where the communication power of the coordinator is reachable.

4. The IEEE 802.15.4 network system according to claim 1, wherein the allocation address information and the allocation ID information of the stationary device transmitted from the coordinator are formed into a first packet preset between the coordinator and the mobile device.

5. The IEEE 802.15.4 network system according to claim 4, wherein the first packet includes an address field and a Virtual Address Table (VAT) field,
wherein the address field has allocation address information related with an address allocated to the mobile device for association with the network, and
wherein the VAT field has the allocation address information and the allocation ID information of the stationary device.

6. The IEEE 802.15.4 network system according to claim 1, wherein the allocation address information and the allocation ID information of the stationary device transmitted from the coordinator are formed into a second packet according to Zigbee alliance specification.

7. The IEEE 802.15.4 network system according to claim 6, wherein the second packet includes Media Access Controller (MAC) payload field, wherein the MAC payload field has the allocation address information and the allocation ID information of the stationary device.

8. The IEEE 802.15.4 network system according to claim 1, wherein the ID indicates a device type according to Zigbee alliance specification.

9. A method of operating an IEEE 802.15.4 network by a mobile device, in which the network includes a coordinator, at least one stationary device and a mobile device, the method comprising:
transmitting an association request command to the coordinator;
upon receiving an acknowledgment from the coordinator in response to the association request command, transmitting a data request command to the coordinator;
upon receiving an acknowledgment from the coordinator in response to the data request command, associating with the network, and upon receiving allocation address information related with an address allocated to the stationary device for association with the network and an allocation ID information allocated to the stationary device and related with an ID indicating a preset device type, transmitting an acknowledgment to the coordinator in response to the allocation address information and the allocation ID information of the stationary device; and
controlling the stationary device based on the allocation address information and the allocation ID information of the stationary device and receiving an acknowledgment from the stationary device in response to the mobile device controlling the stationary device.

10. The method according to claim 9, wherein the controlling (stationary device) step comprises: directly controlling the stationary device without through the coordinator and receiving an acknowledgment from the stationary device in response to the mobile device directly controlling the stationary device.

11. The operating method according to claim 9, wherein the controlling (stationary device) step comprises: directly the stationary device without through the coordinator if the mobile device is out of a preset range, where the communication power of the coordinator is reachable, and receiving an acknowledgment from the stationary device in response to the mobile device directly controlling the stationary device.

12. The method according to claim 9, wherein the allocation address information and the allocation ID information of the stationary device transmitted from the coordinator are formed into a first packet preset between the coordinator and the mobile device.

13. The method according to claim 12, wherein the first packet includes an address field and a Virtual Address Table (VAT) field,
wherein the address field has allocation address information related with an address allocated to the mobile device for association with the network, and
wherein the VAT field has the allocation address information and the allocation ID information of the stationary device.

14. The method according to claim 9, wherein the ID indicates a device type according to Zigbee alliance specification.

15. A method of operating an IEEE 802.15.4 network by a mobile device, in which the network includes a coordinator, at least one stationary device and a mobile device, the method comprising:
transmitting an association request command to the coordinator;
upon receiving an acknowledgment from the coordinator in response to the association request command, transmitting a first data request command to the coordinator, which requests allocation of an address for association with the IEEE 802.15.4 network;
upon receiving an acknowledgment from the coordinator in response to the data request command, associating with the network;
transmitting a second data request command to the coordinator to request allocation address information and allocation ID information from the coordinator, the allocation address information related with an address allocated to the stationary device for association with the network and the allocation ID information related with an ID indicating a preset device type allocated to the stationary device;
receiving an acknowledgment from the coordinator in response to the second data request command, receiving the allocation address information and the allocation ID information of the stationary device from the coordinator, and transmitting an acknowledgment to the coordinator in response to the allocation address information and the allocation ID information of the stationary device; and
controlling the stationary device based on the allocation address information and the allocation ID information of the stationary device and receiving an acknowledgment from the stationary device in response to the mobile device controlling the stationary device.

16. The method according to claim 15, wherein the controlling (stationary device) step comprises: directly controlling the stationary device without through the coordinator and receiving an acknowledgment from the stationary device in response to the mobile device directly controlling the stationary device.

17. The method according to claim 15, wherein the controlling (stationary device) step comprises: directly the stationary device without through the coordinator if the mobile device is out of a preset range, where the communication power of the coordinator is reachable, and receiving an acknowledgment from the stationary device in response to the mobile device directly controlling the stationary device.

18. The method according to claim 15, wherein the allocation address information and the allocation ID information of the stationary device transmitted from the coordinator are formed into a second packet preset according to Zigbee alliance specification.

19. The method according to claim 18, wherein the second packet includes a Media Access Controller (MAC) payload field, wherein the MAC payload field has the allocation address information and the allocation ID information of the stationary device.

20. The method according to claim 15, wherein the ID indicates a type device according to Zigbee alliance specification.
